(19) United States
(12) Patent Application Publication
(10) Pub. No.: US 2025/0282149 A1
(43) Pub. Date: Sep. 11, 2025

(54) PRINTING APPARATUS AND PRINTING METHOD

(71) Applicant: SEIKO EPSON CORPORATION, Tokyo (JP)

(72) Inventors: Hiroki SATO, SHIOJIRI-SHI (JP); Hiroki GODO, SHIOJIRI-SHI (JP); Eri TSUCHIYA, MATSUMOTO-SHI (JP)

(21) Appl. No.: 19/073,257

(22) Filed: Mar. 7, 2025

(30) Foreign Application Priority Data
Mar. 8, 2024 (JP) 2024-036042

(51) Int. Cl. B41J 2/21; B41J 2/045

(52) U.S. Cl. CPC B41J 2/2132; B41J 2/0451; B41J 2/04573; B41J 2/04586; B41J 2/2103

(57) ABSTRACT

A mix section, in a first head, that belongs to an overlap section disposed at a first position in a second direction and a mix section that belongs to an overlap section disposed at the first position in a second head are arranged in a first order so as to differ in terms of a position in the second direction. A mix section, in the first head, that belongs to the overlap section disposed at a second position in the second direction and a mix section that belongs to the overlap section disposed at the second position in the second head are arranged in a second order symmetrical to the first order so as to differ in terms of a position in the second direction.

The present application is based on, and claims priority from JP Application Serial Number 2024-036042, filed on Mar. 8, 2024, the disclosure of which is hereby incorporated by reference herein in its entirety.

### BACKGROUND

### 1. Technical Field

The present disclosure includes a printing apparatus and a printing method.

### 2. Related Art

JP-A-2015-150828 discloses a printer including an inkjet head in which a plurality of chips configured to discharge ink of the same color are disposed in a staggered manner so as to partially overlap with each other. In particular, JP-A-2015-150828 discloses a configuration in which, in the same overlap region (corresponding to an “overlap section” in the present disclosure), the position of a mix region (corresponding to a “mix section” in the present disclosure) of each color is positionally shifted as viewed in the transport direction of a recording medium to suppress banding.

In the configuration disclosed in JP-A-2015-150828, the way of positional shift of the mix region for each color is constant. In a case of such a configuration, a time difference between the timing at which first color ink is discharged from both of two overlapping chips and the timing at which second color ink is discharged from one of other two overlapping chips varies depending on positions of the overlap region. Note that the “position of the overlap region” here represents a position as viewed in a transport direction of a recording medium. Thus, in JP-A-2015-150828 described above, a difference in landing timing between the first color ink and the second color ink varies depending on the position of the overlap region. Thus, there is a problem in which, in a portion of the overlap region, banding having a characteristic differing from banding occurring in other overlap regions occurs, which makes the banding stand out. For this reason, there is a demand for a technique of further improving the quality of printing of an image.

### SUMMARY

A printing apparatus according to the present disclosure includes a head unit configured to discharge a plurality of types of liquid, and a control unit configured to control discharging of the liquid from the head unit, in which the head unit at least includes, as a plurality of heads, a first head provided with three or more chips including a nozzle row including nozzles configured to discharge a first liquid, and a second head provided with three or more chips including a nozzle row including nozzles configured to discharge a second liquid, the first head and the second head are arranged to be spaced apart in a first direction, a layout, in the first head, of the three or more chips of the first head and a layout, in the second head, of the three or more chips of the second head are common, the three or more chips are arranged in a staggered manner in a second direction intersecting the first direction such that adjacent chips have an overlap section as viewed in the first direction, the overlap section in the first head and the overlap section in the second head overlap as viewed in the first direction, the control unit controls discharging of the liquid such that each of the overlap sections includes a mix section in which the liquid is discharged from both of two adjacent chips, of the three or more chips, and a non-mix section in which the liquid is discharged only from one of the two adjacent chips, the mix section that belongs to the overlap section disposed at a first position in the first head and the mix section that belongs to the overlap section disposed at the first position in the second head are arranged in a first order so as to differ in terms of a position in the second direction, the mix section that belongs to the overlap section disposed at a second position in the first head and the mix section that belongs to the overlap section disposed at the second position in the second head are arranged in a second order symmetrical to the first order so as to differ in terms of a position in the second direction, and the first position and the second position are respective positions, in the second direction, of two overlap sections, of the overlap sections, arranged alongside in the second direction.

A method of printing a pattern according to the present disclosure provides a method of printing a pattern printed by using the printing apparatus described above, in which, of the chips provided with the head and arranged in a staggered manner, a group of the chips arranged at the first position in the first direction is set as a first chip group, and a group of the chips arranged at the second position in the first direction is set as a second chip group, the method includes a first discharging step for discharging color ink from the nozzles that belong to a section other than the overlap section, the nozzles that belong to the mix section, and the nozzles that belong to the non-mix section of the one of the two adjacent chips, from among the nozzles of the first chip group, and a second discharging step for discharging the color ink from the nozzles that belong to a section other than the overlap section from among the nozzles of the second chip group, the nozzles that belong to the mix section, and the nozzles that belong to the non-mix section of the one of the two adjacent chips.

### BRIEF DESCRIPTION OF THE DRAWINGS

FIG. 1 is a diagram illustrating the schematic configuration of a printing system according to an embodiment.

FIG. 2 is a schematic view illustrating the configuration of a head unit.

FIG. 3 is a schematic view illustrating a layout of mix sections according to a comparative example.

FIG. 4 is a schematic view illustrating a layout of mix sections according to a comparative example.

FIG. 5 is a schematic view illustrating a layout of mix sections according to the embodiment.

FIG. 6 is a schematic view illustrating a layout of mix sections according to the embodiment.

FIG. 7 is a schematic block diagram illustrating a control system of the printing system according to the embodiment.

FIG. 8 is a diagram used to describe nozzles driven at the time of printing.

FIG. 9 is a schematic view illustrating one example of a pattern printed on a recording medium.

FIG. 10 is a schematic view illustrating a layout of mix sections according to a modification example of the embodiment.

FIG. 11 is a schematic view illustrating one example of a pattern printed on a recording medium.

FIG. 12 is a schematic view illustrating a layout of mix sections according to a modification example of the embodiment.

FIG. 13 is a schematic view illustrating a layout of mix sections according to a comparative example.

### DESCRIPTION OF EMBODIMENTS

Below, each embodiment will be described with reference to the drawings. For the purpose of clarification of description, omission and simplification are made for the following description and drawings as appropriate. In addition, in each drawing, the same elements are denoted by the same reference characters, and description thereof will not be repeated as necessary. Note that, in the present disclosure, the expression “adjacent” is used not only when, between two elements, no element having a type differing from these two elements is interposed, but also used when, between two elements, an element having a type differing from these two elements is interposed. Furthermore, in the present disclosure, the expression “arranged alongside” is used not only when, between plural elements, no element having a type differing from these plural elements is interposed, but also used when, between plural elements, an element having a type differing from these plural elements is interposed.

### Printing System

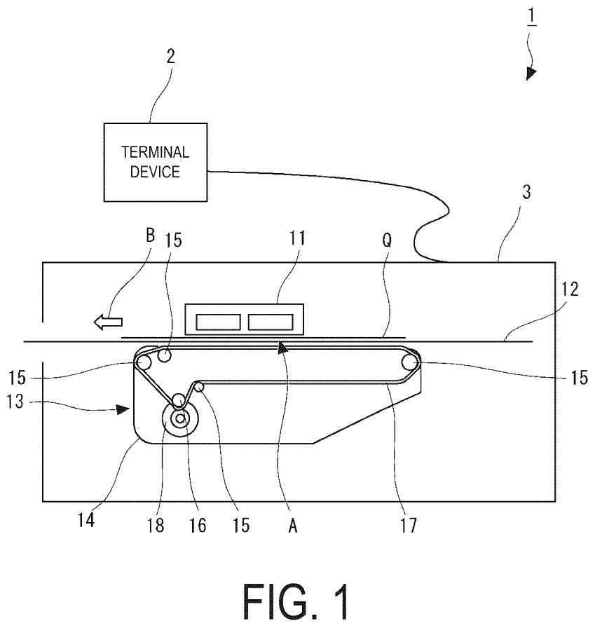

FIG. 1 is a diagram illustrating the schematic configuration of a printing system 1 according to the embodiment. The printing system 1 includes a terminal device 2, and a printing apparatus 3 coupled to the terminal device 2 in a manner that they can communicate with each other.

The printing apparatus 3 includes a head unit 11 configured to be able to discharge a plurality of types of liquid, a medium transport path 12 extending through a printing position A of the head unit 11, and a transport unit 13 serving as a transport mechanism configured to transport a recording medium Q along the medium transport path 12 in a transport direction B. The transport unit 13 is disposed below the head unit 11 in the vertical direction and is mounted at a platen unit 14 that is opposed to the head unit 11 with a predetermined gap being interposed between them. The transport unit 13 includes an endless transporting belt 17 looped over a plurality of guide rollers 15 and a driving roller 16, and a transport motor 18 configured to rotate the driving roller 16 to cause the transporting belt 17 to rotate. With drive of the transport motor 18, the transport unit 13 transports the recording medium Q at a constant velocity.

### Head Unit

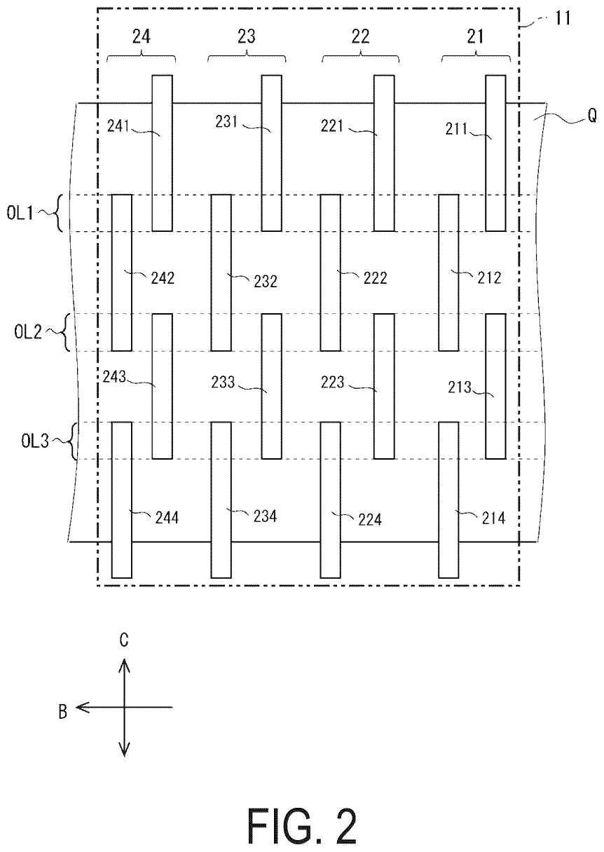

FIG. 2 is a schematic view illustrating the configuration of the head unit 11. As illustrated in FIG. 2, the head unit 11 includes a head 21, a head 22, a head 23, and a head 24 that are four line-type inkjet heads arrayed at predetermined intervals along the transport direction B for the recording medium Q. That is, the head 21, the head 22, the head 23, and the head 24 are arranged at intervals in the transport direction B. For example, these heads are arranged at equal intervals. The head 21, the head 22, the head 23, and the head 24 are each able to discharge a liquid. Specifically, in the present embodiment, the head 21 disposed most upstream in the transport direction B discharges black ink, and the head 22 disposed downstream of the head 21 discharges cyan ink. In addition, the head 23 disposed downstream of the head 22 discharges magenta ink, and the head 24 disposed downstream of the head 23 discharges yellow ink.

The head 21, the head 22, the head 23, and the head 24 each include N pieces of chips arrayed in an intersecting direction C intersecting the transport direction B. Specifically, in the present embodiment, the “N” is four. That is, the head 21, the head 22, the head 23, and the head 24 each include four pieces of chips. Note that, in the present embodiment, the value of “N” is four. However, the “N” is not limited to four, and it is only necessary that the “N” is an integer equal to or more than 3. In addition, more specifically, the intersecting direction C is a direction perpendicular to the transport direction B.

Specifically, in the present embodiment, the head 21 includes a chip 211, a chip 212, a chip 213, and a chip 214. These four pieces of chips 211, 212, 213, and 214 are arranged in a staggered manner along the intersecting direction C. In other words, the four pieces of chips 211, 212, 213, and 214 are arranged front and back in the transport direction B. Thus, the chips of the head 21 can be divided into the following two chip groups. The first chip group of the head 21 is a group of the chips arranged at a predetermined position in the transport direction B, and specifically, is a chip group made of the chip 211 and the chip 213. In addition, the second chip group of the head 21 is a group of the chips arranged at a position in the transport direction B differing from the predetermined position described above, and is a chip group including the chip 212 and the chip 214.

Furthermore, the four pieces of chips 211, 212, 213, and 214 are configured such that chips adjacent to each other partially overlap with each other as viewed in the transport direction B. That is, the chips that the head 21 includes are configured such that chips adjacent to each other are arranged so as to have an overlap section as viewed in the transport direction B. Here, the overlap section represents a section in which two chips that belong to the same head overlap as viewed in the transport direction B. Specifically, the chip 211 and the chip 212 are arranged so as to have an overlap section OL1, as illustrated in FIG. 2. In addition, the chip 212 and the chip 213 are arranged so as to have an overlap section OL2.

Furthermore, the chip 213 and the chip 214 are arranged so as to have an overlap section OL3.

Similarly, the head 22 includes a chip 221, a chip 222, a chip 223, and a chip 224 that are arranged in a staggered manner. Thus, the head 22 includes a first chip group made of the chip 221 and the chip 223 arranged at a predetermined position in the transport direction B, and also includes a second chip group made of the chip 222 and the chip 224 arranged at another position in the transport direction B. The chips that the head 22 includes are also configured such that chips adjacent to each other partially overlap with each other as viewed in the transport direction B. Specifically, the chip 221 and the chip 222 are arranged so as to have the overlap section OL1, as illustrated in FIG. 2. In addition, the chip 222 and the chip 223 are arranged so as to have the overlap section OL2. Furthermore, the chip 223 and the chip 224 are arranged so as to have the overlap section OL3.

Similarly, the head 23 includes a chip 231, a chip 232, a chip 233, and a chip 234 arranged in a staggered manner. Thus, the head 23 includes a first chip group made of the chip 231 and the chip 233 arranged at a predetermined position in the transport direction B, and also includes a second chip group made of the chip 232 and the chip 234 arranged at another position in the transport direction B. The chips that the head 23 includes are also configured such that chips adjacent to each other partially overlap with each other as viewed in the transport direction B. Specifically, the chip 231 and the chip 232 are arranged so as to have the overlap section OL1, as illustrated in FIG. 2. In addition, the chip 232 and the chip 233 are arranged so as to have the overlap section OL2. Furthermore, the chip 233 and the chip 234 are arranged so as to have the overlap section OL3.

Similarly, the head 24 includes a chip 241, a chip 242, a chip 243, and a chip 244 arranged in a staggered manner. Thus, the head 24 includes a first chip group made of the chip 241 and the chip 243 arranged at a predetermined position in the transport direction B, and also includes a second chip group made of the chip 242 and the chip 244 arranged at another position in the transport direction B. The chips that the head 24 includes are also configured such that chips adjacent to each other partially overlap with each other as viewed in the transport direction B. Specifically, the chip 241 and the chip 242 are arranged so as to have the overlap section OL1, as illustrated in FIG. 2. In addition, the chip 242 and the chip 243 are arranged so as to have the overlap section OL2. Furthermore, the chip 243 and the chip 244 are arranged so as to have the overlap section OL3.

Note that, more specifically, in the overlap section OL1 and the overlap section OL3, it can be said that each of the heads is configured such that the left end of the chip disposed upstream as viewed from the upstream of the transport direction

B overlaps with the right end of the chip disposed downstream. Note that the transport direction B represents one direction (one direction from the right to the left in FIG. 2) in which the recording medium Q is transported. Thus, it is obvious that the expression “as viewed in the transport direction B” means “viewing from the upstream of the transport direction B.” For this reason, below, “viewing from the upstream of the transport direction B” is simply referred to as “as viewed in the transport direction B.” For example, in a case of the head 21, in the overlap section OL1, the left end of the chip 211 disposed upstream in the transport direction B and the right end of the chip 212 disposed downstream overlap with each other, and in the overlap section OL3, the left end of the chip 213 disposed upstream in the transport direction B and the right end of the chip 214 disposed downstream overlap with each other. In contrast, in the overlap section OL2, it can be said that each of the heads is configured such that the right end of the chip disposed upstream as viewed in the transport direction B and the left end of the chip disposed downstream overlap with each other. Note that FIG. 2 only illustrates one example of the configuration of the head unit 11. The positions of the first chip group and the second chip group in the transport direction B in each of the heads may be positions inverted from the positions illustrated in FIG. 2.

As can be understood from the description above and FIG. 2 concerning the head 21 to the head 24, the layout, in the head 21, of four pieces of chips of the head 21, the layout, in the head 22, of four pieces of chips of the head 22, the layout, in the head 23, of four pieces of chips of the head 23, and the layout, in the head 24, of four pieces of chips of the head 24 are common to each other. That is, the layouts of these chips are the same. Note that, as described above, in the present embodiment, the number of chips that each of the heads includes is not limited to four. Thus, when “N” is the number of chips that each of the heads includes, the following can be applied to all integers n that satisfy 1≤n≤N−1. The n-th overlap section in the head 21, the n-th overlap section in the head 22, the n-th overlap section in the head 23, and the n-th overlap section in the head 24 exist at the same position in the intersecting direction C. In other words, the n-th overlap sections of the individual heads that are counted in the intersecting direction C exist at the same position as viewed in the transport direction B. That is, the n-th overlap sections of the individual heads that are counted in the intersecting direction C overlap with each other as viewed in the transport direction B. Note that, in the present disclosure, the overlap sections are counted in the order from the right side as viewed in the transport direction B, that is, in the order from the upper side in FIG. 2. That is, the overlap section located at the rightmost position as viewed in the transport direction B is referred to as the first overlap section. In this manner, the n-th overlap section counted from the right side as viewed in the transport direction B exists at the same position for all the heads as viewed in the transport direction B. Thus, it can be said that the overlap section OL1 is an overlap section common to the individual heads. This similarly applies to the overlap sections OL2 and OL3.

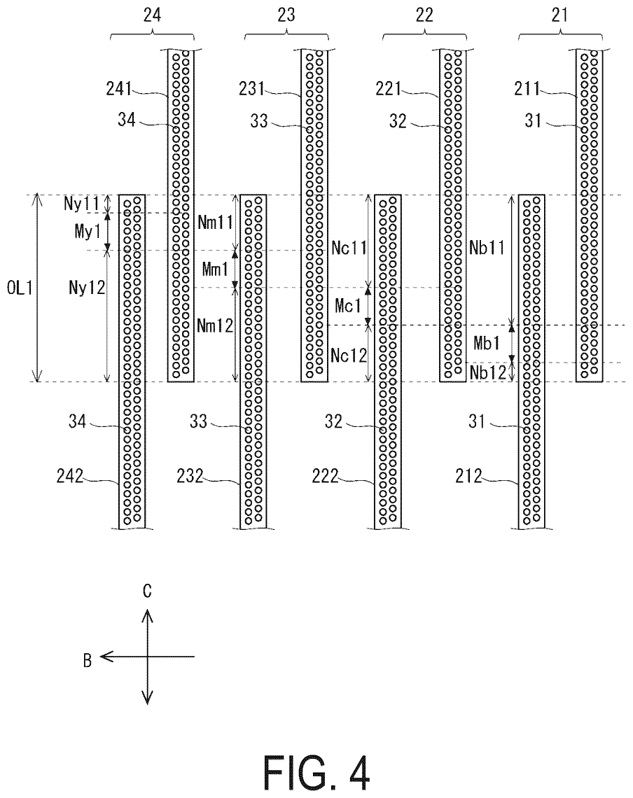

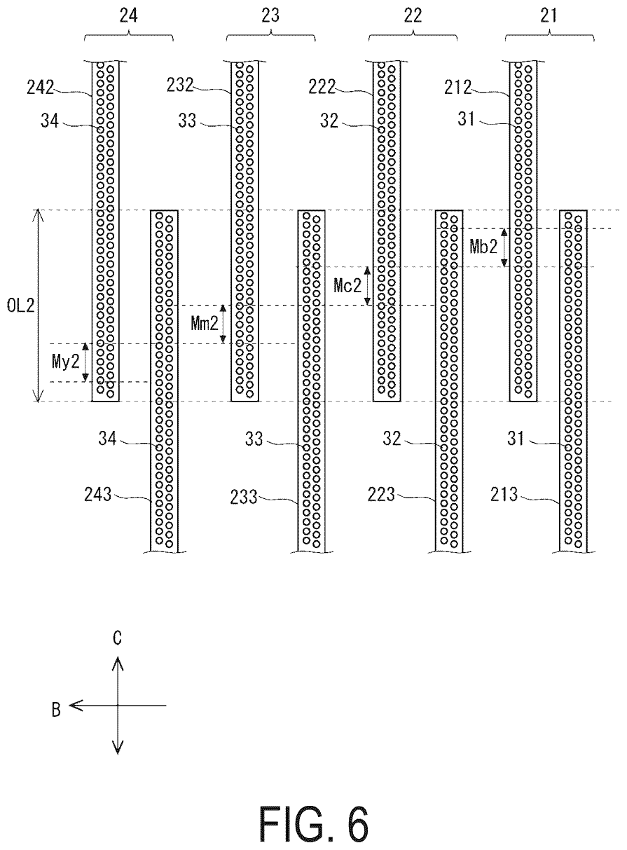

Each of the chips of each of the heads includes a plurality of nozzles arrayed in the intersecting direction C, as illustrated in FIGS. 4 or 6 that will be described later. The plurality of nozzles of each of the chips are arranged in a staggered manner in the intersecting direction C. In other words, the plurality of nozzles of each of the chips are arranged front and back in the transport direction B to constitute a nozzle row. Specifically, nozzles 31 of each of the chips 211, 212, 213, and 214 of the head 21 are configured to discharge black ink to the recording medium Q. In addition, nozzles 32 of each of the chips 221, 222, 223, and 224 of the head 22 are configured to discharge cyan ink to the recording medium Q. Nozzles 33 of each of the chips 231, 232, 233, and 234 of the head 23 are configured to discharge magenta ink to the recording medium Q. Furthermore, nozzles 34 of each of the chips 241, 242, 243, and 244 of the head 24 are configured to discharge yellow ink to the recording medium Q. The layout of the nozzles 31 in the head 21, the layout of the nozzles 32 in the head 22, the layout of the nozzles 33 in the head 23, and the layout of the nozzles 34 in the head 24 are common. That is, these layouts are the same.

### Comparative Example

Next, description will be made of a comparative example serving as one trigger for reaching an idea of the present embodiment. In a section other than the overlap section, any of the color ink is discharged only from one chip. In addition, in the overlap section, it is possible to discharge color ink from both of two chips that overlap with each other. Here, the mix section represents a section of the overlap section in which color ink is discharged from both of two chips. More specifically, the mix section is a section defined in the overlap section as viewed in the transport direction B, and is a section in which color ink is discharged from both of two adjacent chips arranged so as to have the overlap section. In addition, the non-mix section represents a section of the overlap section in which color ink is discharged only from one chip of two adjacent chips. Note that it can be said that the mix section is a section of the overlap section configured to discharge ink from two chips to form an image on the recording medium Q. Furthermore, it can be said that the non-mix section is a section of the overlap section configured to discharge ink from one chip to form an image on the recording medium Q.

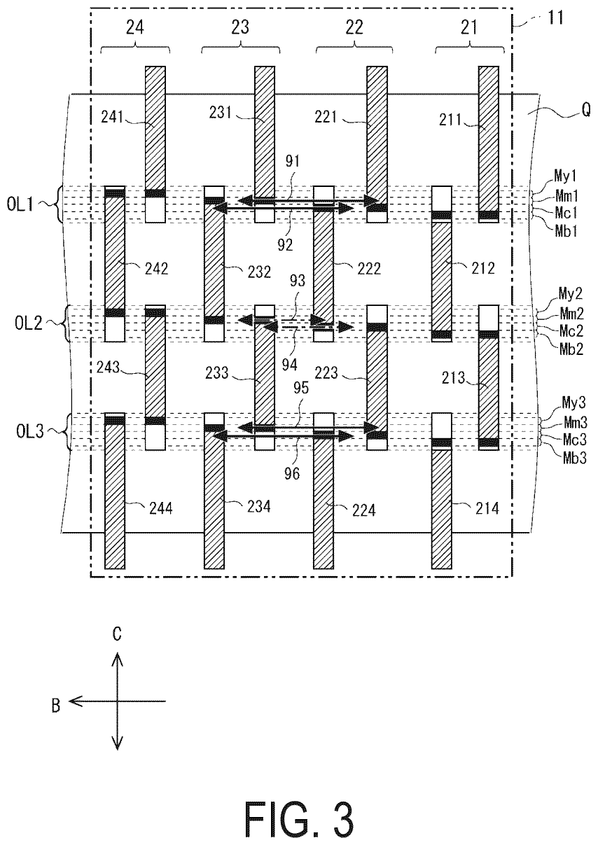

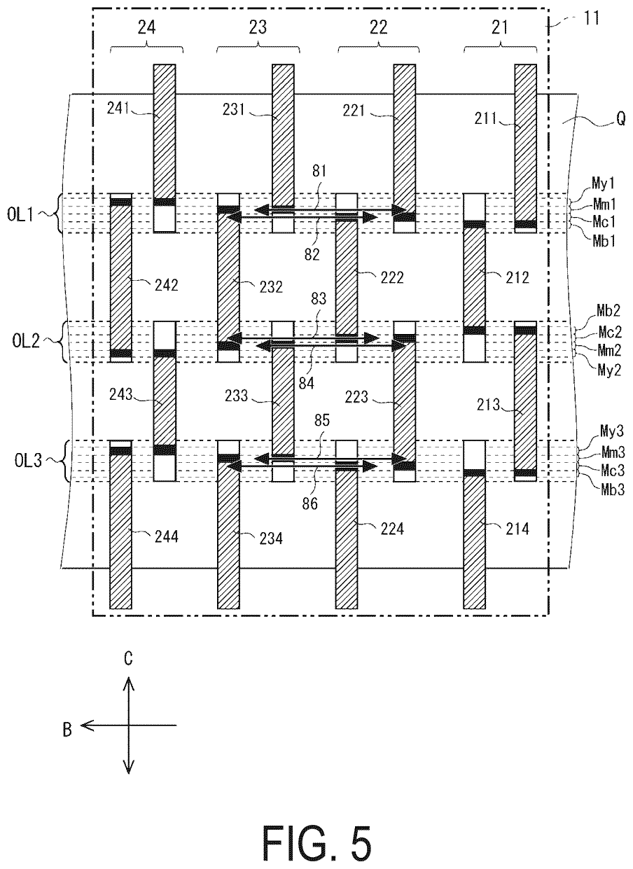

FIG. 3 is a schematic view illustrating a layout of mix sections according to a comparative example. In FIG. 3 as well as FIGS. 5, 10, 12, and 13 that will be described later, a region of each of the chips where the nozzles that belong to the mix section are distributed is illustrated in a solid-fill manner, and hatching is applied to a region other than such a region and where ink is discharged. Thus, a region to which neither solid fill nor hatching is applied indicates a region where nozzles that are not used are distributed. As in FIG. 3, FIG. 4 is a schematic view illustrating the layout of mix sections according to a comparative example, and in particular, is a schematic view illustrating the layout of mix sections in the overlap section OL1.

Note that, as described above, in the non-mix section of the overlap section, color ink is discharged only from one chip of two chips that overlap with each other. Specifically, of two chips that overlap with each other, a chip from which color ink is discharged in the non-mix section is a chip in which this non-mix section is disposed more at the center side of the chip than the mix section. This similarly applies to the embodiment. Note that, more specifically, the “more at the center side of the chip” means the center of the chip in the intersecting direction C. The chip from which ink is discharged in the non-mix section will be specifically described with reference to FIG. 4.

As illustrated in FIG. 4, the overlap section OL1 of the head 21 includes a non-mix section Nb11 and a non-mix section Nb12, in addition to a mix section Mb1. Here, in the chip 211, the non-mix section Nb11 is disposed more at the center side of the chip 211 than the mix section Mb1, and in the chip 212, the non-mix section Nb11 is disposed more at a tip side of the chip 212 than the mix section Mb1. In addition, in the chip 211, the non-mix section Nb12 is disposed more at the tip side of the chip 211 than the mix section Mb1, and in the chip 212, the non-mix section Nb12 is disposed more at the center side of the chip 212 than the mix section Mb1. Thus, the chip from which black ink is discharged in the non-mix section Nb11 is the chip 211 of which non-mix section Nb11 is set more at the center side of the chip than the mix section Mb1, from among two chips 211 and 212 that overlap with each other. In addition, the chip from which black ink is discharged in the non-mix section Nb12 is the chip 212 of which non-mix section Nb12 is set more at the center side of the chip than the mix section Mb1, from among two chips 211 and 212 that overlap with each other. In other words, of the non-mix section Nb11 and the non-mix section Nb12 each included in the overlap section OL1 of the head 21, a section in which the chip 211 discharges color ink is the non-mix section Nb11 that is included in the chip 211 and continues with a section that is outside of the overlap section OL1, and a section in which the chip 212 discharges color ink is the non-mix section Nb12 that is included in the chip 212 and continues with a section that is outside of the overlap section OL1.

Similarly, a chip of the head 22 from which cyan ink is discharged in the non-mix section Nc11 of the overlap section OL1 is the chip 221 that is a chip of which non-mix section Nc11 is set more at the center side of the chip than the mix section Mc1, from among two chips 221 and 222 that overlap with each other. In addition, a chip of the head 22 from which cyan ink is discharged in the non-mix section Nc12 of the overlap section OL1 is the chip 222 that is a chip of which non-mix section Nc12 is set more at the center side of the chip than the mix section Mc1, from among two chips 221 and 222 that overlap with each other. Furthermore, a chip of the head 23 from which magenta ink is discharged in the non-mix section Nm11 of the overlap section OL1 is the chip 231 that is a chip of which non-mix section Nm11 is set more at the center side of the chip than the mix section Mm1, from among two chips 231 and 232 that overlap with each other. In addition, a chip of the head 23 from which magenta ink is discharged in the non-mix section Nm12 of the overlap section OL1 is the chip 232 that is a chip of which non-mix section Nm12 is set more at the center side of the chip than the mix section Mm1, from among two chips 231 and 232 that overlap with each other. Furthermore, a chip of the head 24 from which yellow ink is discharged in the non-mix section Ny11 of the overlap section OL1 is the chip 241 that is a chip of which non-mix section Ny11 is set more at the center side of the chip than the mix section My1, from among two chips 241 and 242 that overlap with each other. In addition, a chip of the head 24 from which yellow ink is discharged in the non-mix section Ny12 of the overlap section OL1 is the chip 242 that is a chip of which non-mix section Ny12 is set more at the center side of the chip than the mix section My1, from among two chips 241 and 242 that overlap with each other. These are descriptions of the chips that discharge ink in the non-mix sections of the overlap section OL1. However, other overlap sections will be described in a similar manner.

In the comparative example, the mix sections of each of the heads are arranged so as to be positionally shifted in the intersecting direction C with the same pattern. Specifically, each of the mix sections is arranged in the following manner, as illustrated in FIGS. 3 and 4. Note that, in the comparative example and the embodiment, each of the overlap sections includes four partial sections that do not overlap with each other, and the mix section is disposed in any one of the partial sections. Note that, in the present disclosure, these four partial sections are sequentially referred to as a first partial section, a second partial section, a third partial section, and a fourth partial section in the order from the right side as viewed from the upstream in the transport direction B, that is, in the order from the upper side in FIGS. 3 and 4. In the overlap section OL1, the mix section Mb1 of the head 21 is disposed in the fourth partial section of the overlap section OL1. In addition, in the overlap section OL1, the mix section Mc1 of the head 22 is disposed in the third partial section. The mix section Mm1 of the head 23 is disposed in the second partial section. The mix section My1 of the head 24 is disposed in the first partial section. Similarly, in the overlap section OL2, the mix section Mb2 of the head 21 is disposed in the fourth partial section. The mix section Mc2 of the head 22 is disposed in the third partial section. The mix section Mm2 of the head 23 is disposed in the second partial section. The mix section My2 of the head 24 is disposed in the first partial section. Furthermore, in the overlap section OL3, the mix section Mb3 of the head 21 is disposed in the fourth partial section. The mix section Mc3 of the head 22 is disposed in the third partial section. The mix section Mm3 of the head 23 is disposed in the second partial section. The mix section My3 of the head 24 is disposed in the first partial section. In this manner, the way of positional shift of mix regions for each of the colors is constant.

By positionally shifting the mix sections from color to color in the overlap section as in the comparative example, it is possible to achieve an effect of suppressing occurrence of the banding. However, even with the comparative example, it is still a challenging to completely eliminate the banding. The layout of the mix sections according to the comparative example still has the following problem in terms of occurrence of the banding.

In FIG. 3, the arrows 91 to 96 each indicate a substantial distance between a nozzle of the first head that discharges ink and a nozzle of the second head that discharges ink in a partial section in which a mix section of any one head of the first head and the second head exists. Note that the first head and the second head are heads adjacent to each other. In FIG. 3, attention is paid to the head 22 and the head 23 as the first head and the second head. Here, discussion will be made by paying attention to the head 22 and the head 23. However, the following matters are also applied to other adjacent head pairs. Note that, in FIG. 3 and FIGS. 5, 10, 12, and 13, the individual arrows each indicating the distance are drawn such that the arrows for two chips that discharge the same color ink are illustrated by setting the middle point between these chips as a substantial nozzle position.

As illustrated in FIG. 3, the arrows 93 and 94 in the overlap section OL2 are shorter than the arrows 91, 92, 95, and 96 in the overlap section OL1 or OL3. This means that, in the overlap section OL2, a time interval from when ink (that is, cyan ink) discharged from the head 22 lands on the recording medium Q to when ink (that is, magenta ink) discharged from the head 23 lands on the recording medium Q differs from the other overlap sections. Specifically, in the example illustrated in FIG. 3, the time interval of landing in the overlap section OL2 is shorter than those in the other overlap sections. In this manner, in a case of the layout of the mix sections described in the comparative example, since the way of positional shift of the mix regions from color to color is constant, the time interval of landing in the overlap section OL2 differs from those in the other overlap sections. Thus, in the overlap section OL2, banding having a characteristic differing from banding occurring in the other overlap regions OL1 and OL3 occurs, which makes the banding stand out. For this reason, the present embodiment employs the layout of the mix sections differing from the layout in the comparative example.

FIG. 5 is a schematic view illustrating the layout of the mix sections according to the embodiment. In addition, FIG. 6 is a schematic view illustrating the layout of the mix sections according to the embodiment as in FIG. 5 and in particular, is a schematic view illustrating the layout of the mix sections in the overlap section OL2.

In the present embodiment, the mix sections of each of the heads are also arranged so as to be positionally shifted in the intersecting direction C. In the present embodiment, however, the positions of the mix sections are not shifted in a similar manner for all the overlap sections. Two symmetrical ways of positional shifting are alternately employed for overlap section to overlap section. Specifically, as illustrated in FIGS. 5 and 6, the individual mix sections are arranged in the following manner.

In a case of the present embodiment, in the overlap section OL1, the mix sections of each of the heads are arranged in a manner similar to the comparative example. That is, in the overlap section OL1, the mix section Mb1 of the head 21 is arranged in the fourth partial section of the overlap section OL1. In addition, in the overlap section OL1, the mix section Mc1 of the head 22 is arranged in the third partial section. The mix section Mm1 of the head 23 is disposed in the second partial section. The mix section My1 of the head 24 is disposed in the first partial section. That is, in the overlap section OL1, the individual mix sections of each of the heads 21, 22, 23, and 24 arranged in the transport direction B are disposed such that, as the position of the head goes toward the downstream in the transport direction B, the position of the mix section is disposed at the right side as viewed from the upstream in the transport direction B. That is, the mix sections of each of the heads arranged in the transport direction B are arranged in the order from the left as viewed from the upstream in the transport direction B. In this manner, the overlap section OL1 employs the layout of the mix sections as illustrated in FIG. 4.

In addition, in the overlap section OL2, the mix sections of each of the heads are arranged symmetrically to the arrangement of the mix sections in the overlap section OL1, as illustrated in FIGS. 5 and 6. Here, the “arranged symmetrically” more specifically means an axial symmetrical arrangement with an axis parallel to the transport direction B being the axis of symmetry. That is, in the overlap section OL2, the mix section Mb2 of the head 21 is disposed in the first partial section of the overlap section OL2. In addition, in the overlap section OL2, the mix section Mc2 of the head 22 is disposed in the second partial section. The mix section Mm2 of the head 23 is disposed in the third partial section. The mix section My2 of the head 24 is disposed in the fourth partial section. That is, in the overlap section OL2, the mix sections of each of the heads 21, 22, 23, and 24 arranged in the transport direction B are arranged such that, as the position of the head goes downstream in the transport direction B, the position of the mix section goes toward the left side as viewed from the upstream in the transport direction B. That is, the mix sections of each of the heads arranged in the transport direction B are arranged sequentially from the right as viewed from the upstream in the transport direction B.

In addition, in the overlap section OL3, the mix sections of each of the heads are arranged in a manner similar to that in the overlap section OL1. That is, in the overlap section OL3, the mix section Mb3 of the head 21 is disposed in the fourth partial section of the overlap section OL3. In addition, in the overlap section OL3, the mix section Mc3 of the head 22 is disposed in the third partial section. The mix section Mm3 of the head 23 is disposed in the second partial section. The mix section My3 of the head 24 is disposed in the first partial section. In this manner, the layout of the mix sections as illustrated in FIG. 4 is also employed for the overlap section OL3, as with the overlap section OL1.

Note that, in the present embodiment, the mix sections are set so as not to include an end portion (more specifically, an end portion in the intersecting direction C) of the overlap section. However, the mix sections may be set so as to include the end portion of the overlap portion. That is, in the present embodiment, the mix sections are set so as not to use a nozzle that belongs to a tip portion of each of the chips in the intersecting direction C. However, the mix sections may be set so as to use such a nozzle.

In the description below, the layout of the mix sections as illustrated in FIG. 4 is referred to as a descending order for the purpose of convenience. This is because the mix sections of each of the heads are arrayed sequentially from the fourth partial section, the third partial section, the second partial section, and the first partial section, as viewed in the transport direction B. Similarly, the layout of the mix sections as illustrated in FIG. 6 is referred to as an ascending order for the purpose of convenience.

Here, the time interval of landing of two colors of ink in the present embodiment will be discussed. In FIG. 5, the arrows 81 to 86 each indicate a substantial distance between a nozzle of the first head that discharges ink and a nozzle of the second head that discharges ink in a partial section in which a mix section of any one head of the first head and the second head exists. Note that the first head and the second head are heads adjacent to each other. In FIG. 5, attention is also paid to the head 22 and the head 23 as the first head and the second head. Here, discussion will be made by paying attention to the head 22 and the head 23. However, the following matters are also applied to other adjacent head pairs.

As described above, the present embodiment employs the symmetrical arrangement of the mix sections for each of the overlap sections. That is, in the present embodiment, the descending order and the ascending order are alternately employed for individual overlap sections. Thus, the lengths of the arrow 81 to the arrow 86 are the same as illustrated in FIG. 5. This means that, in the partial section in which the mix section exists, the time interval from when ink discharged from the head 22 lands on the recording medium Q to when ink discharged from the head 23 lands on the recording medium Q is constant regardless of the overlap sections. Thus, it is possible to suppress occurrence of the specific banding as seen in the comparative example.

By setting the number of nozzles of each of the chips to “N” to perform generalization, the present embodiment has the following characteristic in terms of the layout of the mix sections. The following can be said for all odd numbers i that satisfy 1≤i≤N-1. The mix section that belongs to the i-th overlap section in the head 21, the mix section that belongs to the i-th overlap section in the head 22, the mix section that belongs to the i-th overlap section in the head 23, and the mix section that belongs to the i-th overlap section in the head 24 are arranged in a predetermined order in the intersecting direction C. In particular, these mix sections are arranged in the predetermined order such that positions thereof in the intersecting direction C differ from each other. In the present embodiment, this predetermined order is an order referred to as the descending order for the purpose of convenience. In addition, the following can be said for all even numbers j that satisfy 1≤j≤N-1. The mixing section that belongs to the j-th overlap section in the head 21, the mix section that belongs to the j-th overlap section in the head 22, the mix section that belongs to the j-th overlap section in the head 23, and the mix section that belongs to the j-th overlap section in the head 24 are arranged in the symmetrical order in the intersecting direction C. In particular, these mix sections are arranged in the symmetrical order such that the positions thereof in the intersecting direction C differ from each other. Here, the symmetrical order is an order symmetrical to the predetermined order described above, and in the present embodiment, is an order referred to as the ascending order for the purpose of convenience. The layout of the mix sections arranged in the predetermined order and the layout of the mix sections arranged in the symmetrical order are axial symmetric with an axis parallel to the transport direction B being the axis of symmetry.

In addition, the arrangement of the mix sections in the head unit 11 can also be described in the following manner. Note that positions, in the intersecting direction C, of two overlap sections that are arranged alongside in the intersecting direction C are referred to as a first position and a second position. In addition, four heads that the head unit 11 includes are referred to as the first head, the second head, a third head, and a fourth head. In this case, it can be said that four mix sections concerning the first head to the fourth head that belong to the overlap section disposed at the first position are arranged in a first order (predetermined order) such that positions thereof in the intersecting direction C differ from each other. In addition, four mix sections concerning the first head to the fourth head that belong to the overlap section disposed at the second position are arranged in a second order (symmetrical order) symmetrical to the first order so as to differ from each other in terms of the position in the intersecting direction C.

Furthermore, when the number of chips that each of the heads of the head unit 11 includes is equal to or more than five, the arrangement of the mix sections of the head unit 11 can be described in the following manner. In this case, four overlap sections that are arranged alongside in the intersecting direction C exists. Thus, positions of these four overlap sections are referred to as the first position, the second position, a third position, and a fourth position. In this case, four mix sections concerning the first head to the fourth head that belong to the overlap section disposed at the first position are arranged in the first order (predetermined order) such that positions thereof in the intersecting direction C differ from each other, as described above. In addition, four mix sections concerning the first head to the fourth head that belong to the overlap section disposed at the second position are arranged in the second order (symmetrical order) such that positions thereof in the intersecting direction C differ from each other. Furthermore, it can be said that four mix sections concerning the first head to the fourth head that belong to the overlap section disposed at the third position are arranged in the first order (predetermined order) such that positions thereof in the intersecting direction C differ from each other. In addition, it can be said that four mix sections concerning the first head to the fourth head that belong to the overlap section disposed at the fourth position are arranged in the second order (symmetrical order) such that positions thereof in the intersecting direction C differ from each other. In this manner, the first order (predetermined order) and the second order (symmetrical order) are repeated from overlap section to overlap section. Note that the first position, the second position, the third position, and the fourth position described above are more specifically defined in the following manner. The first position is a position of the first overlap section counted in the intersecting direction C from among four overlap sections that are arranged alongside in the intersecting direction C. The second position is a position of the second overlap section counted in the intersecting direction C from among four overlap sections that are arranged alongside in the intersecting direction C. The third position is a position of the third overlap section counted in the intersecting direction C from among four overlap sections that are arranged alongside in the intersecting direction C. The fourth position is a position of the fourth overlap section counted in the intersecting direction C from among four overlap sections that are arranged alongside in the intersecting direction C.

Note that, in the present embodiment, the number of the head units 11 is four. However, it is only necessary that the number of the heads that the head unit 11 includes is equal to or more than two. When the number of heads that the head unit 11 includes is two or three rather than four, or when the number of heads that the head unit 11 includes is equal to or more than five, the arrangement of the mix sections can be described in a manner similar to that described above.

In addition, in the descending order or the ascending order described above, the mix sections of each of the heads are arranged in a staircase pattern in the overlap section, as illustrated in FIGS. 4 or 6. That is, the descending order or the ascending order illustrated in FIG. 4 or FIG. 6 is configured in the following manner. Note that, below, the “k” is any given integer that satisfies 1≤k ≤N−1. The mix section that belongs to the k-th overlap section in the head 21 and the mix section that belongs to the k-th overlap section in the head 22 are adjacent to each other in the intersecting direction C. In addition, the mix section that belongs to the k-th overlap section in the head 22 and the mix section that belongs to the k-th overlap section in the head 23 are adjacent to each other in the intersecting direction C. Furthermore, the mix section that belongs to the k-th overlap section in the head 23 and the mix section that belongs to the k-th overlap section in the head 24 are adjacent to each other in the intersecting direction C.

In addition, the arrangement of the mix sections in a staircase pattern illustrated in FIG. 4 or FIG. 6 can be described in the following manner as the arrangement of the mix sections in the head unit that includes at least three heads. Note that, here, three heads that the head unit 11 includes are referred to as a first head, a second head, and a third head. In this case, two mix sections arranged in the first order (predetermined order) or the second order (symmetrical order) concerning two heads adjacent to each other in the transport direction B from among the first head, the second head, and the third head are adjacent to each other in the intersecting direction C. For example, the mix section Mb1 and the mix section Mc1 arranged in the first order (predetermined order) concerning the head 21 and the head 22 adjacent to each other in the transport direction B are adjacent to each other in the intersecting direction C, as illustrated in FIG. 4. Similarly, the mix section Mc1 and the mix section Mm1 arranged in the first order (predetermined order) concerning the head 22 and the head 23 adjacent to each other in the transport direction B are adjacent to each other in the intersecting direction C. Similarly, the mix section Mm1 and the mix section My1 arranged in the first order (predetermined order) concerning the head 23 and the head 24 adjacent to each other in the transport direction B are adjacent to each other in the intersecting direction C. Here, description has been specifically made with reference to FIG. 4. However, similarly, description can be also made of the mix sections arranged in the second order (symmetrical order) as illustrated in FIG. 6. In this manner, a control unit 550 that will be described later sets the individual mix sections such that two mix sections arranged in the first order or the second order concerning two heads adjacent to each other in the transport direction B from among the first head, the second head, and the third head are adjacent to each other in the intersecting direction C. With this configuration, the mix sections of each of the heads 21, 22, 23, and 24 arranged in the transport direction B are configured such that, as the position of the head goes downstream in the transport direction B, the position of the mix section is shifted toward a certain direction as viewed from the upstream in the transport direction B. That is, the mix sections are arranged in a staircase pattern.

By disposing the mix regions in a staircase pattern, it is possible to make constant the time interval of landing of ink on the recording medium Q in the mix sections of two heads adjacent in the transport direction B, regardless of a combination of two adjacent heads. That is, in FIG. 5, when “T” represents a time interval of landing in the mix sections of the head 22 and the head 23 indicated by the arrow 81 to the arrow 86, the time interval of landing in the mix sections of the head 21 and the head 22 and the time interval of landing in the mix section of the head 23 and the head 24 are all T. Thus, for example, even if heads in charge of cyan and magenta are changed from the head 22 and the head 23 into the head 23 and head 24, the time interval of landing of these two colors remains unchanged. For this reason, when specifications of the printing apparatus change, it is possible to flexibly deal with this change.

### Control System of Printing System

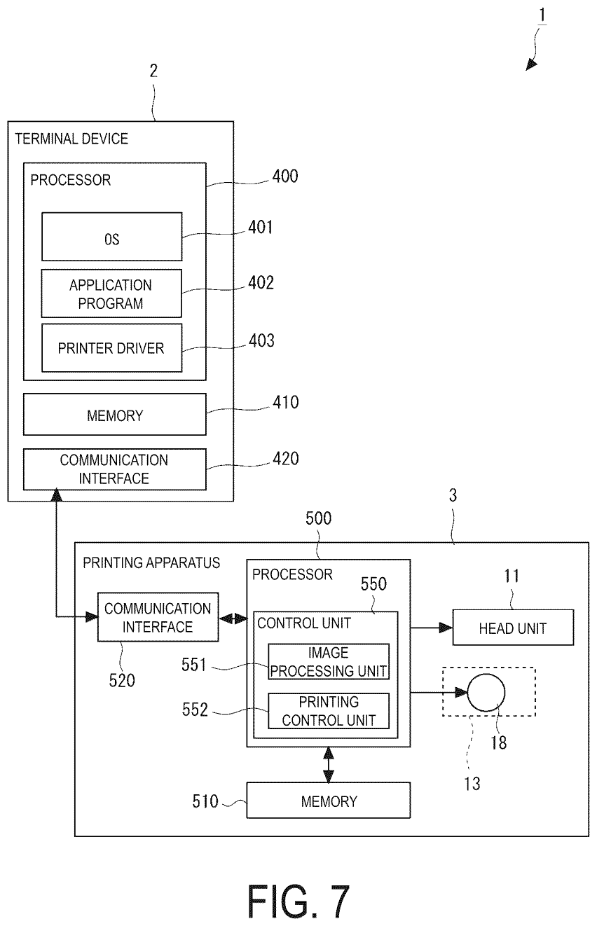

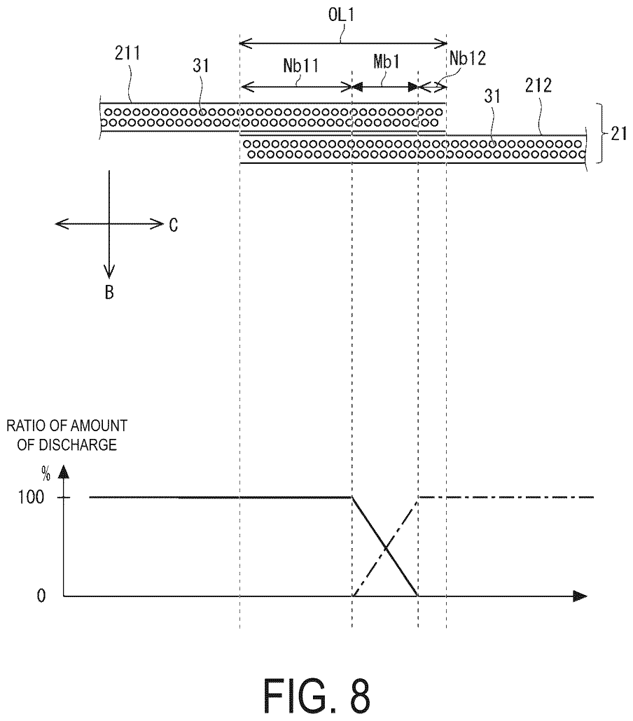

FIG. 7 is a schematic block diagram illustrating a control system of the printing system 1. FIG. 8 is a diagram used to describe nozzles driven at the time of printing.

The terminal device 2 includes a processor 400, a memory 410, and a communication interface 420, and has a function of a computer.

The memory 410 is configured by, for example, a combination of a volatile memory and a nonvolatile memory. The memory 410 is used to hold a program to be executed by the processor 400, data used for various processes, and the like. The communication interface 420 is an interface used to communicate with the printing apparatus 3.

The processor 400 reads out the program from the memory 410 to execute it. With this configuration, the processor 400 achieves functions of an operating system (OS) 401, an application program 402, and a printer driver 403. The processor 400 may be, for example, a microprocessor, micro processor unit (MPU), a central processing unit (CPU), or the like. The processor 400 may include a plurality of processors.

The OS 401 is software that controls operations of the terminal device 2. In addition, the application program 402 is software that creates image data. The printer driver 403 receives the image data from the application program 402 through the OS 401, and supplies it to the printing apparatus 3.

The printing apparatus 3 includes a processor 500, a memory 510, and a communication interface 520, and has functions of a computer.

The memory 510 is comprised of, for example, a combination of a volatile memory and a nonvolatile memory. The memory 510 is used to hold a program to be executed by the processor 500, data used for various processes, and the like. The communication interface 520 is an interface used to communicate with the terminal device 2.

The processor 500 reads out the program from the memory 510 to execute it. With this configuration, the processor 500 achieves the function of the control unit 550. The processor 500 may be, for example, a microprocessor, an MPU, or a CPU. The processor 500 may include a plurality of processors.

The communication interface 520 receives the image data supplied from the terminal device 2 (printer driver 403), and inputs it into the processor 500. The head unit 11 and the transport motor 18 are coupled to the processor 500 through a device driver (not illustrated).

The control unit 550 controls printing. That is, the control unit 550 controls discharging of a liquid (ink) from the head unit 11 and transporting of the recording medium Q. In particular, as described above, the control unit 550 controls discharging of ink such that each of the overlap sections includes the mix sections and the non-mix sections arranged as described above. In the present embodiment, the control unit 550 includes an image processing unit 551 and a printing control unit 552 in order to control printing. The image processing unit 551 first performs rendering processing to the image data inputted into the processor 500, and converts each pixel of the image data into RGB data. Here, R represents red, G represents green, and B represents blue. Next, the image processing unit 551 refers to a look-up table to convert the RGB data concerning each pixel into CMYK data. Here, C represents cyan, M represents magenta, Y represents yellow, and K represents black. Next, the image processing unit 551 performs halftone processing on the basis of the CMYK data to generate print data in a format in which the printing apparatus 3 is able to interpret. Note that, when generating the print data, the image processing unit 551 may adjust the amount of discharge of ink in order to suppress the banding. The print data is a group of command used to discharge ink from each of the nozzles of the head unit 11, and gives an instruction as to a nozzle (that is, a nozzle caused to discharge ink) to be driven. The print data is also referred to as dot data. In this manner, the image processing unit 551 generates the print data used to drive the nozzles of each of the heads of the head unit 11 on the basis of the image data.

In particular, when generating the print data, the image processing unit 551 sets the mix sections and the non-mix sections to each of the overlap sections in the manner described above, to generate the print data. Thus, the image processing unit 551 generates print data for driving nozzles of both of two adjacent chips for the mix sections in the overlap section, and generates print data for driving nozzles of one chip of the two adjacent chips for the non-mix section in the overlap section and a section other than the overlap section.

In other words, the image processing unit 551 generates print data for driving nozzles of both of two adjacent chips for a pixel to be formed in a portion of the recording medium Q passing through the printing position A, this portion corresponding to the mix section. In addition, the image processing unit 551 generates print data for driving nozzles of one chip of two adjacent chips for a pixel to be formed in a portion of the recording medium Q passing through the printing position A, the portion corresponding to the non-mix section or corresponding to a section other than the overlap section.

Note that the print data for driving the mix sections may be data for controlling the ratio of the amount of discharge of ink from two adjacent chips in the following manner, in order to suppress the banding due to an individual difference between individual nozzles or the like. FIG. 8 is a schematic view used to describe a ratio of the amount of discharge of ink from two adjacent chips. In FIG. 8, the chip 211 and the chip 212 are illustrated as representatives of two adjacent chips. More specifically, the upper section of FIG. 8 schematically illustrates the overlap section OL1 of the chip 211 and the chip 212 of the head 21 and its surroundings, and the lower section of FIG. 8 is a graph showing the ratio of the amount of discharge from the chip 211 and the chip 212. As illustrated in FIG. 8, the image processing unit 551 may generate the following print data. Note that, here, a chip (chip 211 in FIG. 8) of the two adjacent chips that exists at one side in the intersecting direction C is referred to as the first chip, and a chip (chip 212 in FIG. 8) of the two adjacent chips that exists at the other side in the intersecting direction C is referred to as the second chip. The image processing unit 551 may generate print data configured such that, in a mix section, the amount of discharge from each nozzle of the first chip reduces as nozzles go toward the other side in the intersecting direction C, and in this mix section, the amount of discharge from each nozzle of the second chip reduces as nozzles go toward the one side in the intersecting direction C. However, such control of the amount of discharge is merely one example, and the amount of discharge may not be necessarily controlled in this manner.

Note that, in particular, in the present embodiment, the mix sections are arranged by the control unit 550 in the following manner. That is, the two mix sections arranged in the first order (predetermined order) or the second order (symmetrical order) and adjacent in the intersecting direction C are adjacent to each other without any space between them, as illustrated in FIGS. 4 and 6. That is, no non-mix section is inserted between such two mix sections as viewed in the transport direction B. For example, two mix sections including the mix sections Mb1 and the mix section Mc1 arranged in the first order and adjoining in the intersecting direction C are adjacent to each other without any space being provided between them in the intersecting direction C, as illustrated in FIG. 4. Similarly, two mix sections including the mix sections Mc1 and the mix section Mm1 arranged in the first order and adjoining in the intersecting direction C are adjacent to each other without any space being provided between them in the intersecting direction C. Similarly, two mix sections including the mix sections Mm1 and the mix section My1 arranged in the first order and adjoining in the intersecting direction C are adjacent to each other without any space being provided between them in the intersecting direction C. Here, description has been specifically made with reference to FIG. 4. However, similarly, description can be also made of the mix sections arranged in the second order (symmetrical order) as illustrated in FIG. 6. The characteristic described above can also be described in the following manner. For all integers n that satisfy 1≤n≤N−1, mix sections belonging to the n-th overlap section and adjoining in the intersecting direction C are arranged so as to be adjacent. By disposing the mix sections without any space being provided between them in this manner, it is possible to set the mix section so as to be longer within the overlap section, as compared with a case where the mix sections are provided with a space being provided between them. Thus, when, in a mix section, the amount of discharge of ink is reduced in accordance with the position in the intersecting direction C as illustrated in FIG. 8, it is possible to make gentle the change in the amount of discharge of ink in accordance with the positions. Thus, it is possible to more effectively suppress the banding resulting from a difference in the performance of nozzles in two adjacent chips. In particular, as the number of heads mounted at the head unit 11 increases, the number of mix sections disposed within the overlap section also increases. Thus, when the number of heads mounted at the head unit 11 is large as in the present embodiment, it is particularly preferable to arrange the mix sections without provided any space between them.

Once print data is generated, the printing control unit 552 drives the transport motor 18 to transport the recording medium Q along the medium transport path 12 at a predetermined velocity. Furthermore, the printing control unit 552 drives the head unit 11 on the basis of the print data to perform printing on the recording medium Q at the printing position A. That is, the printing control unit 552 controls discharge of ink from each of the heads on the basis of the print data to perform printing on the recording medium Q.

These are descriptions of the printing apparatus 3 according to the embodiment. Unlike the comparative example described above, with the printing apparatus 3, the way of positional shift of the mix regions for each of the colors is devised. Thus, it is possible to suppress a case where banding occurs in a portion of the overlap sections, and this banding has a characteristic differing from banding occurring in the other overlap sections, which makes the banding stand out. In addition, banding occurring in individual overlap sections are at the same level. This makes it easy to suppress banding by adjusting the amount of discharge of ink, as compared with a case where various levels of banding occur.

Incidentally, the printing apparatus 3 is able to print any given image on the recording medium Q in accordance with control by the control unit 550. In addition, the printing apparatus 3 may print a check pattern used to check the presence or absence of a failure (for example, clogging of a nozzle) of a nozzle of the head unit 11.

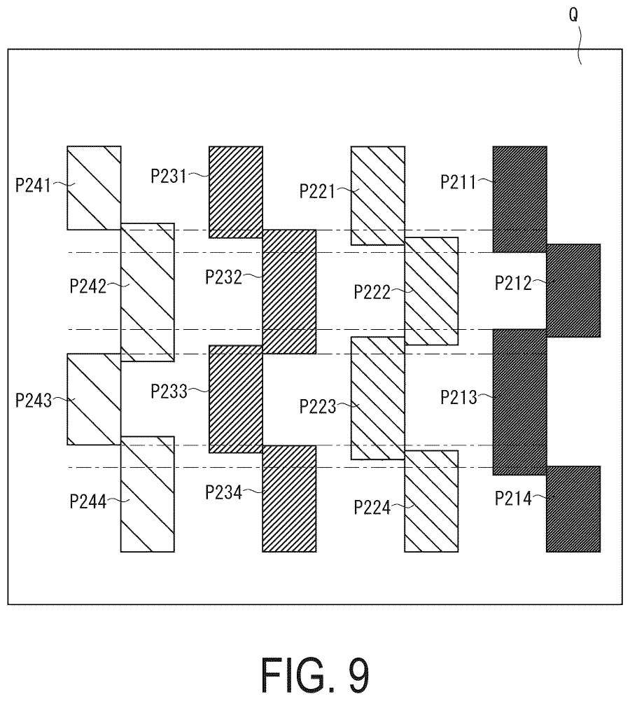

FIG. 9 is a schematic view illustrating one example of a pattern printed on the recording medium Q to check the presence or absence of a failure of a nozzle in the head unit 11 when, in each of the overlap sections, the mix sections and the non-mix sections are arranged as in FIG. 5. More specifically, FIG. 9 is a schematic plan view illustrating the recording medium Q on which a pattern is printed. In FIG. 9, the test pattern printed on the recording medium Q includes patches P211 to P214 printed by the head 21, patches P221 to P224 printed by the head 22, patches P231 to P234 printed by the head 23, and patches P241 to P244 printed by the head 24. Here, more specifically, the patch P211 is printed by the chip 211. The patch P212 is printed by the chip 212. The patch P213 is printed by the chip 213. The patch P214 is printed by the chip 214. Such a correspondence relationship between the patch and the chip similarly applies to the other patches.

On the basis of control by the control unit 550, ink is discharged from nozzles that belong to a section other than the overlap section, nozzles that belong to the mix section, and nozzles that belong to the non-mix section and also belong to a chip in charge of discharging of the ink, thereby performing printing. For example, the patch P211 is printed such that, of all the nozzles of the chip 211, ink is discharged from nozzles disposed in a section other than the overlap section OL1, nozzles in the mix section Mb1, and nozzles in the non-mix section Nb11 (see FIG. 4). That is, of the nozzles of the chip 211, nozzles other than these nozzles, that is, nozzles in Nb12 in the overlap section OL1 are not used for printing the test pattern.

In order to print the test pattern as illustrated in FIG. 9, the control unit 550 performs the following control while transporting the recording medium Q.

First, the control unit 550 performs control such that yellow ink is discharged from nozzles used to print the patch P241 and the patch P243 from among nozzles of the chip 241 and the chip 243 of the head 24. Next, the control unit 550 performs control such that yellow ink is discharged from nozzles used to print the patch P242 and the patch P244 from among nozzles of the chip 242 and the chip 244 of the head 24.

Next, the control unit 550 performs control such that magenta ink is discharged from nozzles used to print the patch P231 and the patch P233 from among nozzles of the chip 231 and the chip 233 of the head 23. Next, the control unit 550 performs control such that magenta ink is discharged from nozzles used to print the patch P232 and the patch P234 from among nozzles of the chip 232 and the chip 234 of the head 23.

Next, the control unit 550 performs control such that cyan ink is discharged from nozzles used to print the patch P221 and the patch P223 from among nozzles of the chip 221 and the chip 223 of the head 22. Next, the control unit 550 performs control such that cyan ink is discharged from nozzles used to print the patch P222 and the patch P224 from among nozzles of the chip 222 and the chip 224 of the head 22.

Next, the control unit 550 performs control such that black ink is discharged from nozzles used to print the patch P211 and the patch P213 from among nozzles of the chip 211 and the chip 213 of the head 21. Next, lastly, the control unit 550 performs control such that black ink is discharged from nozzles used to print the patch P212 and the patch P214 from among nozzles of the chip 212 and the chip 214 of the head 21. Note that provided here is an example in which the test pattern is printed in the order of printing of a patch by the head 24 (yellow ink), printing of a patch by the head 23 (magenta ink), printing of a patch by the head 22 (cyan ink), and printing of a patch by the head 21 (black ink). However, when the test pattern is printed on the recording medium Q, it is possible to employ any given order for the order of colors of the printed patches. For example, printing of the test pattern may progress in the reversed order to the order described above, that is, may progress in the order of printing of a patch by the head 21 (black ink), printing of a patch by the head 22 (cyan ink), printing of a patch by the head 23 (magenta ink), and printing of a patch by the head 24 (yellow ink).

With such a test pattern being printed, it is possible to obtain a test pattern suitable to check a failure of a nozzle actually used in the printing apparatus 3 according to the present embodiment. Note that in the test pattern illustrated in FIG. 9, patches for all the heads are printing. However, only patches for a portion of the heads may be printed, or only patches for a portion of the chips of a portion of the heads may be printed.

### Modification Example

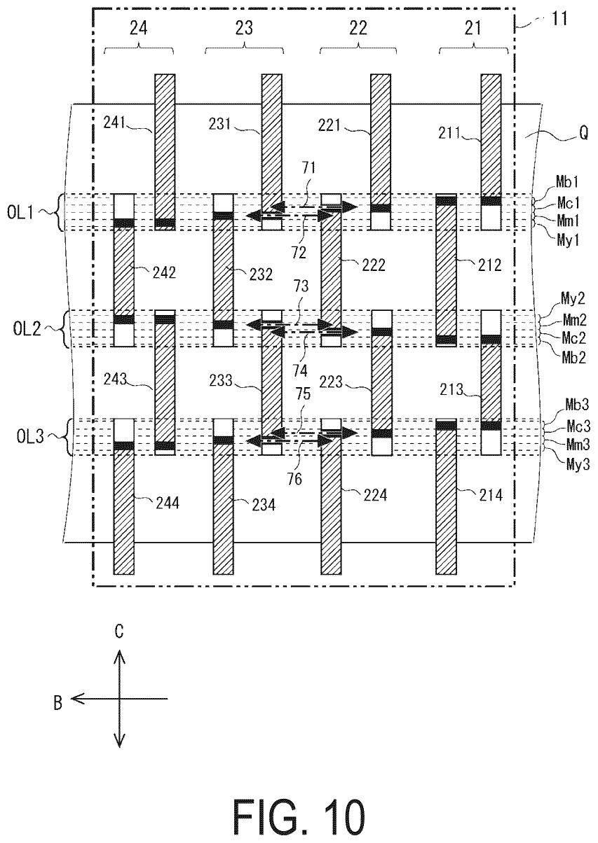

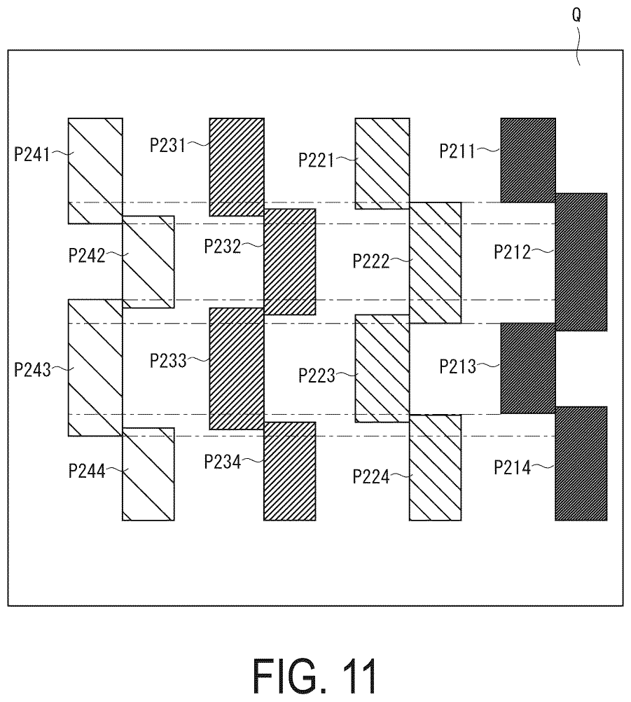

In the layout of the mix sections illustrated in FIG. 5, the mix sections are arranged in the descending order in the overlap section OL1 and the overlap section OL3, and the mix sections are arranged in the ascending order in the overlap section OL2. However, as illustrated in FIG. 10, the mix sections are arranged in the ascending order in the overlap section OL1 and the overlap section OL3, and the mix sections are arranged in the descending order in the overlap section OL2. That is, it is only necessary that the ascending order and the descending order are repeated from overlap section to overlap section. In this case, the lengths (that is, time intervals of landing of ink) of the arrows 71 to 76 are equal. Note that, when the layout of the mix sections as illustrated in FIG. 10 is set, a test pattern as illustrated in FIG. 11 is printed by the printing apparatus 3 as a pattern printed on the recording medium Q in order to check the presence or absence of a failure of a nozzle of the head unit 11.

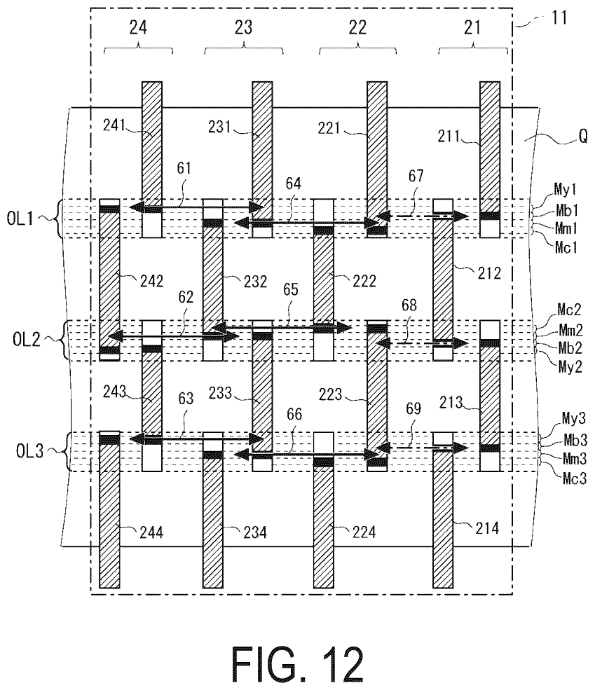

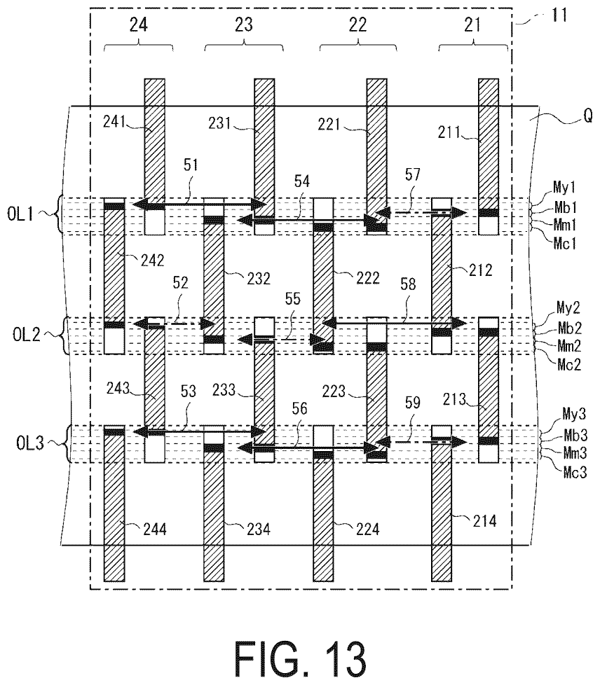

Furthermore, in the layout of the mix sections illustrated in FIG. 5 or FIG. 10, the mix sections of each of the heads in the same overlap section are arranged in a staircase pattern. However, the mix sections may not necessarily be arranged in a staircase pattern. For example, the mix sections may be arranged in a manner as illustrated in FIG. 12. The example of the layout of the mix sections illustrated in FIG. 12 is obtained by correcting the layout of the mix section illustrated in FIG. 13 that is the comparative example. In the example illustrated in FIG. 13, the layout of the mix sections of each of the heads is not arranged in a staircase pattern but is arranged in the equal layout for all the overlap sections. In contrast, in the example illustrated in FIG. 12, the layout of the mix sections of each of the heads in the overlap section OL2 is arranged symmetrically to the layout of the mix sections of each of the heads in the overlap section OL1 and the overlap section OL3.

In FIG. 12, the arrows 61 to 69 each indicate a substantial distance in a mix section between a nozzle, which discharges ink, of one head of two heads adjacent in the transport direction B and a nozzle of the other head that discharges ink. Similarly, in FIG. 13, the arrows 51 to 59 each indicate a substantial distance in a mix section between a nozzle, which discharges ink, of one head of two heads adjacent in the transport direction B and a nozzle of the other head that discharges ink. As illustrated in FIG. 13, for any pair of heads, the length (that is, the time interval of landing of ink) of the arrow in the overlap section OL2 differs from the lengths (that is, the time interval of landing of ink) of the arrows in the overlap sections OL1 and OL3. In contrast, in the example illustrated in FIG. 12, the length (that is, the time interval of landing of ink) of the arrow between the head 21 and the head 22 is the same regardless of the overlap sections. Similarly, in FIG. 12, the length (that is, the time interval of landing of ink) of the arrow between the head 22 and the head 23 is the same regardless of the overlap sections. In addition, the length (that is, the time interval of landing of ink) of the arrow between the head 23 and the head 24 is the same regardless of the overlap sections. This makes it possible to suppress the occurrence of the banding as with the embodiment described above. However, in the embodiment described above in which the mix sections are arrange in a staircase pattern, the time interval of landing of ink is a constant time T for all the pairs of the heads. However, in the example of the layout illustrated in FIG. 12, the time interval (arrows 67, 68, and 69) of landing of ink in the pair of the head 21 and the head 22 differs from that of the pair of the other heads as illustrated in FIG. 12.

Furthermore, in the embodiment described above, the image processing unit 551 is mounted at the printing apparatus 3. However, the image processing unit 551 may be mounted at the terminal device 2 side. In this case, the printing apparatus 3 and the terminal device 2 may be collectively referred to as a printing apparatus. That is, the printing system 1 may be referred to as the printing apparatus.

Note that, in the present disclosure, when read in a computer, a program includes a group of commands (or software code) for causing the computer to perform one or more functions described in the embodiment. The program may be stored in a non-transitory computer-readable medium or a tangible storage medium. By way of example and not limitation, computer-readable media or tangible storage media include random-access memory (RAM), read-only memory (ROM), flash memory, solid-state drive (SSD) or other memory technology, CD-ROM, digital versatile disk (DVD), Blu-ray (trade name) disk or other optical disk storage, magnetic cassettes, magnetic tapes, magnetic disk storage, or other magnetic storage device. The program may be transmitted through a transitory computer-readable medium or a communication medium. By way of example and not limitation, the transitory computer-readable medium or a communication medium includes an electrical-type, an optical-type, an acoustical-type, or other types of propagation signal.

Note that the present disclosure is not limited to the embodiment described above and the modification examples thereof, and can be appropriately changed without departing from the gist.

Some of or all of the embodiment and modification examples described above can also be described as the following Appendixes, but are not limited to the followings.

### Appendix 1

A printing apparatus including:
a head unit configured to discharge a plurality of types of liquid; and
a control unit configured to control discharging of the liquid from the head unit, in which
the head unit at least includes
a first head provided with three or more chips including a nozzle row including nozzles configured to discharge a first liquid, and
a second head provided with three or more chips including a nozzle row including nozzles configured to discharge a second liquid,
the first head and the second head are arranged to be spaced apart in a first direction,
a layout, in the first head, of the three or more chips of the first head and a layout, in the second head, of the three or more chips of the second head are common,
the three or more chips are arranged in a staggered manner in a second direction such that adjacent chips have an overlap section as viewed in the first direction, the second direction being a direction intersecting the first direction,
the overlap section in the first head and the overlap section in the second head overlap as viewed in the first direction,
the control unit controls discharging of the liquid such that each of the overlap sections includes a mix section in which the liquid is discharged from both of two adjacent chips, of the three or more chips, and a non-mix section in which the liquid is discharged only from one of the two adjacent chips,
the mix section that belongs to the overlap section disposed at a first position in the second direction in the first head and the mix section that belongs to the overlap section disposed at the first position in the second head are arranged in a first order so as to differ in terms of a position in the second direction,
the mix section that belongs to the overlap section disposed at a second position in the second direction in the first head and the mix section that belongs to the overlap section disposed at the second position in the second head are arranged in a second order symmetrical to the first order so as to differ in terms of a position in the second direction, and
the first position and the second position are positions, in the second direction, of two overlap sections, of the overlap sections, arranged alongside in the second direction.

### Appendix 2

The printing apparatus according to Appendix 1 is configured such that
the first head and the second head each include five or more chips,
the mix section that belongs to the overlap section disposed at a third position in the second direction in the first head and the mix section that belongs to the overlap section disposed at the third position in the second head are arranged in the first order so as to differ in terms of a position in the second direction,
the mix section that belongs to the overlap section disposed at a fourth position in the second direction in the first head and the mix section that belongs to the overlap section disposed at the fourth position in the second head are arranged in the second order so as to differ in terms of a position in the second direction,
the first position, the second position, the third position, and the fourth position are respective positions in the second direction of four overlap sections, of the overlap sections, arranged alongside in the second direction,
the first position is a position of a first overlap section counted in the second direction among the four overlap sections,
the second position is a position of a second overlap section counted in the second direction among the four overlap sections,
the third position is a position of a third overlap section counted in the second direction among the four overlap sections, and
the fourth position is a position of a fourth overlap section counted in the second direction among the four overlap sections.

### Appendix 3

The printing apparatus according to Appendix 1 or 2 is configured such that two mix sections arranged in the first order or the second order and adjoining in the second direction are adjacent without a space.

### Appendix 4

The printing apparatus according to any one of Appendixes 1 to 3 is configured such that the head unit further includes a third head provided with three or more chips including a nozzle row including nozzles configured to discharge a third liquid,
the first head, the second head, and the third head are arranged to be spaced apart in the first direction,
a layout, in the first head, of the three or more chips of the first head, a layout, in the second head, of the three or more chips of the second head, and a layout, in the third head, of the three or more chips of the third head are common,
the overlap section in the first head, the overlap section in the second head, and the overlap section in the third head overlap as viewed in the first direction,
the mix section that belongs to the overlap section disposed at the first position in the second direction in the first head, the mix section that belongs to the overlap section disposed at the first position in the second head, and the mix position that belongs to the overlap section disposed at the first position in the third head are arranged in the first order so as to differ in terms of a position in the second direction,
the mix section that belongs to the overlap section disposed at the second position in the second direction in the first head, the mix section that belongs to the overlap section disposed at the second position in the second head, and the mix position that belongs to the overlap section disposed at the second position in the third head are arranged in the second order so as to differ in terms of a position in the second direction, and
two mix sections, of the mix sections, arranged in the first order or the second order in two heads adjacent in the first direction among the first head, the second head, and the third head are adjacent in the second direction.

### Appendix 5

A method of printing a pattern printed by using the printing apparatus described in any one of Appendixes 1 to 4, in which
of the chips provided with the head and arranged in a staggered manner, a group of the chips arranged at the first position in the first direction is set as a first chip group, and a group of the chips arranged at the second position in the first direction is set as a second chip group,
the method includes:
a first discharging step for discharging color ink from the nozzles that belong to a section other than the overlap section, the nozzles that belong to the mix section, and the nozzles that belong to the non-mix section of the one of the two adjacent chips, from among the nozzles of the first chip group; and
a second discharging step for discharging the color ink from the nozzles that belong to a section other than the overlap section from among the nozzles of the second chip group, the nozzles that belong to the mix section, and the nozzles that belong to the non-mix section of the one of the two adjacent chips.

What is claimed is:

1. A printing apparatus comprising:
a head unit configured to discharge a plurality of types of liquid; and
a control unit configured to control discharging of the liquid from the head unit, wherein
the head unit at least includes, as a plurality of heads,
a first head provided with three or more chips including a nozzle row including nozzles configured to discharge a first liquid, and
a second head provided with three or more chips including a nozzle row including nozzles configured to discharge a second liquid,
the first head and the second head are arranged to be spaced apart in a first direction,
a layout, in the first head, of the three or more chips of the first head and a layout, in the second head, of the three or more chips of the second head are common,
the three or more chips are arranged in a staggered manner in a second direction intersecting the first direction such that adjacent chips have an overlap section as viewed in the first direction,
the overlap section in the first head and the overlap section in the second head overlap as viewed in the first direction,
the control unit controls discharging of the liquid such that each of the overlap sections includes a mix section in which the liquid is discharged from both of two adjacent chips, of the three or more chips, and a non-mix section in which the liquid is discharged only from one of the two adjacent chips,
the mix section that belongs to the overlap section disposed at a first position in the first head and the mix section that belongs to the overlap section disposed at the first position in the second head are arranged in a first order so as to differ in terms of a position in the second direction,
the mix section that belongs to the overlap section disposed at a second position in the first head and the mix section that belongs to the overlap section disposed at the second position in the second head are arranged in a second order symmetrical to the first order so as to differ in terms of a position in the second direction, and
the first position and the second position are positions, in the second direction, of two overlap sections, of the overlap sections, arranged alongside in the second direction.

2. The printing apparatus according to claim 1, wherein
the first head and the second head each include five or more chips, the mix section that belongs to the overlap section disposed
at a third position in the second direction in the first head and the mix section that belongs to the overlap section disposed at the third position in the second head are arranged in the first order so as to differ in terms of a position in the second direction,
the mix section that belongs to the overlap section disposed at a fourth position in the second direction in the first head and the mix section that belongs to the overlap section disposed at the fourth position in the second head are arranged in the second order so as to differ in terms of a position in the second direction,
the first position, the second position, the third position, and the fourth position are respective positions in the second direction of four overlap sections, of the overlap sections, arranged alongside in the second direction,
the first position is a position of a first overlap section counted in the second direction among the four overlap sections,
the second position is a position of a second overlap section counted in the second direction among the four overlap sections,
the third position is a position of a third overlap section counted in the second direction among the four overlap sections, and
the fourth position is a position of a fourth overlap section counted in the second direction among the four overlap sections.

3. The printing apparatus according to claim 1, wherein
two mix sections arranged in the first order or the second order and adjoining in the second direction are adjacent without a space.

4. The printing apparatus according to claim 1, wherein
the head unit further includes a third head provided with three or more chips including a nozzle row including nozzles configured to discharge a third liquid,
the first head, the second head, and the third head are arranged to be spaced apart in the first direction,
a layout, in the first head, of the three or more chips of the first head, a layout, in the second head, of the three or more chips of the second head, and a layout, in the third head, of the three or more chips of the third head are common,
the overlap section in the first head, the overlap section in the second head, and the overlap section in the third head overlap as viewed in the first direction,
the mix section that belongs to the overlap section disposed at the first position in the second direction in the first head, the mix section that belongs to the overlap section disposed at the first position in the second head, and the mix position that belongs to the overlap section disposed at the first position in the third head are arranged in the first order so as to differ in terms of a position in the second direction,
the mix section that belongs to the overlap section disposed at the second position in the second direction in the first head, the mix section that belongs to the overlap section disposed at the second position in the second head, and the mix position that belongs to the overlap section disposed at the second position in the third head are arranged in the second order so as to differ in terms of a position in the second direction, and
two mix sections, of the mix sections, arranged in the first order or the second order in two heads adjacent in the first direction among the first head, the second head, and the third head are adjacent in the second direction.

5. A method of printing a pattern printed by using the printing apparatus described in claim 1,
of the chips provided with the head and arranged in a staggered manner, a group of the chips arranged at the first position in the first direction is set as a first chip group, and a group of the chips arranged at the second position in the first direction is set as a second chip group,
the method comprising:
a first discharging step for discharging color ink from the nozzles that belong to a section other than the overlap section, the nozzles that belong to the mix section, and the nozzles that belong to the non-mix section of the one of the two adjacent chips, from among the nozzles of the first chip group; and
a second discharging step for discharging the color ink from the nozzles that belong to a section other than the overlap section from among the nozzles of the second chip group, the nozzles that belong to the mix section, and the nozzles that belong to the non-mix section of the one of the two adjacent chips.
